(19) United States
(12) Patent Application Publication
(10) Pub. No.: US 2023/0093913 A1
(43) Pub. Date: Mar. 30, 2023

(54) APPARATUS FOR LOCALLY RECOGNIZING AN INSTRUCTION OF A GIVEN INSTRUCTION SET

(71) Applicant: WAGO Verwaltungsgesellschaft mbH, Minden (DE)

(72) Inventors: Marco HENKEL, Minden (DE); Jannik RATHERT, Petershagen (DE); Dominik HENKEL, Petershagen (DE)

(73) Assignee: WAGO Verwaltungsgesellschaft mbH, Minden (DE)

(21) Appl. No.: 17/707,582

(22) Filed: Mar. 29, 2022

(30) Foreign Application Priority Data
Sep. 30, 2021 (DE) 20 2021 105 276.7

(51) Int. Cl. G10L 15/22; G10L 15/16; G10L 25/18; H04R 1/08; H04R 3/00

(52) U.S. Cl. CPC G10L 15/22; G10L 15/16; G10L 25/18; H04R 1/08; H04R 3/00; G10L 2015/223

(57) ABSTRACT

An apparatus for locally recognizing an instruction of a given set of instructions. The apparatus includes an acoustic sensor configured to convert acoustic signals into electric signals and includes an electronic circuit configured to switch from a first state to a second state based on first acoustic signals that are converted into electric signals and configured to ignore second acoustic signals that are converted into electric signals when the electronic circuit is in the first state and to assign the second acoustic signals to the instruction when the electronic circuit is in the second state.

This nonprovisional application claims priority under 35 U.S.C. § 119(a) to German Patent Application No. 20 2021 105 276.7, which was filed in Germany on Sep. 30, 2021, and which is herein incorporated by reference.

### BACKGROUND OF THE INVENTION

### Field of the Invention

The present invention relates to an apparatus for locally recognizing an instruction of a given instruction set. In particular, the present invention relates to the local recognition of an instruction of a given instruction set by means of neural networks.

### Description of the Background Art

Voice assistants used for recognizing spoken instructions (for voice control) may record ambient noise by means of acoustic sensors and transmit them via an existing network connection to powerful servers that evaluate the ambient noise with respect to the presence of spoken instructions and, if an instruction is recognized, transmit the instruction to the voice assistant or another data processing unit which processes the instruction.

### SUMMARY OF THE INVENTION

It is therefore an object of the present invention to provide an apparatus including an acoustic sensor configured to convert acoustic signals into electric signals, and an electronic circuit. The electronic circuit is configured to switch from a first state to a second state based on first acoustic signals which are converted into electric signals, and to ignore second acoustic signals converted into electric signals when the electronic circuit is in the first state, and to assign the second acoustic signals to the instruction when the electronic circuit is in the second state.

In this regard, the term “acoustic sensor”, can be understood, in particular, to denote a sensor which is configured to pick up sound waves (in the audible frequency range, e.g., in the range from 20 Hz to 20 kHz, or in a portion of the audible frequency range, e.g., in the range from 200 Hz to 5 kHz) and to convert the sound waves into electric signals. Furthermore, the term “electronic circuit”, can be understood, in particular, to denote a circuit with a processor and a storage unit, wherein the processor is configured to execute a program that is stored in the storage unit and which comprises a sequence of commands.

Moreover, the phrase “acoustic signals converted into electric signals”, can be understood, in particular, to denote an analog or digital representation (of at least a part and/or a characteristic) of the acoustic waves to which the acoustic sensor is exposed. Moreover, the phrase “to assign acoustic signals converted into electric signals to an instruction”, can be understood, in particular, to denote an assignment that causes the instruction to be executed by the apparatus, or by a device that is communicatively coupled to the apparatus, when the acoustic sensor records acoustic signals that are to be assigned to the instruction in accordance with an assignment rule, an assignment algorithm, or pattern recognition on which the assignment is based.

For example, if the spoken instruction “lights on” is detected, the apparatus, or a device supplied with the instruction by the apparatus, may establish an electrical connection for powering a light source and, if the instruction “lights off” is detected, disconnect the electrical connection. Moreover, the term “given instruction set”, can be understood, in particular, to denote a set with a fixed number of predetermined instructions, such as, for example, “lights on”, “lights brighter”, “lights dimmer”, “lights off”, “lower blinds”, “blinds down”, “raise blinds”, “blinds up”, “raise temperature”, “decrease temperature”.

The instruction set may be defined by the manufacturer (and non-modifiable by the user) or may be defined by a commissioning technician or the user within the context of a configuration and/or training phase. In the training phase, the instructions of the instruction set may be spoken by different people, so that different acoustic signals can be assigned to the same instruction. Moreover, the same instruction may be repeated several times by one person in order to improve the (probability of correct) instruction recognition.

The first acoustic signals may immediately precede the second acoustic signals and indicate to the electronic circuit that the second acoustic signals include a spoken instruction of the instruction set.

The first acoustic signals may be, for example, a wake-up instruction which signals to the apparatus that the subsequent acoustic signals (probably) include (or represent) a spoken instruction from the instruction set. In this case, the electronic circuit may be configured to limit a time span which is to be evaluated after the detection of the wake-up instruction to a certain value, so that only instructions are recognized that are spoken directly after the wake-up instruction and do not exceed a certain length (e.g., 1 to 3 seconds). The electronic circuit may also be configured to allow, for the recognition of the wake-up instruction, only audio sequences that do not exceed a certain length (e.g., 1 to 3 seconds).

To this end, the electronic circuit may be configured to determine the beginning and the end of an acoustic signal. For example, the electronic circuit may be configured to determine the beginning and the end of the acoustic signal from a signal intensity curve. In addition, the electronic circuit may be configured to always process audio sequences of a certain length. In this case, the electronic circuit may be configured to reject audio sequences in which a time span between the start and the end is greater than a certain value, and to extend audio sequences in which a time span between the start and the end is smaller than a certain value. To extend, the electronic circuit may add null values before the start of the audio sequence and/or append null values after the end of the audio sequence. Furthermore, the circuit may be configured to subject the acoustic signals converted into electric signals to signal processing during which the electric signals are translated into a spectrogram (of a fixed frequency range).

The electronic circuit may be configured to switch back to the first state if the instruction is not recognized and/or in response to another instruction of the instruction set.

For example, the circuit may be configured to detect whether an instruction of the instruction set is spoken within a time interval (e.g., 1 to 3 seconds) following a wake word, and, if not (i.e., if the circuit does not recognize any instruction) return to the rest state in which the electronic circuit analyzes audio sequences only for the wake word.

In this case, the state change and the instruction assignment may be realized by means that are independent of each other and differ from each other with regard to resource consumption.

In particular, the apparatus may be configured to provide fewer resources for the state change than for the instruction assignment.

For example, the resource consumption for recognizing a single wake word may be smaller than the resource consumption for recognizing an instruction of the instruction set, because only a single word may be looked after when recognizing the wake word, whereas different words may be looked after when recognizing an instruction of the instruction set.

The electronic circuit may be configured to subject the electric signals to a frequency analysis.

A spectrogram can be derived from the electric signals by means of the frequency analysis. In this case, the circuit may be configured to ensure that the spectrograms generated by means of the frequency analysis always have the same size, i.e., that they are represented by an equal (or almost equal) number of data points. If necessary, spectrograms may be supplemented with null values. If, for example, audio sequences of different lengths are analyzed (i.e., if the length of the audio sequences is not standardized), the spectrograms may be brought into a uniform length by prefixing and/or appending null values.

The electronic circuit may comprise a processor and a storage unit which stores a program that is to be executed by the processor, wherein the program implements a first artificial neural network.

The first artificial neural network may be trained with speech samples to recognize the wake word. In this process, one or several speech samples of one or several users may be used.

The storage unit may store a further program that is to be executed by the processor. The further program may implement a second artificial neural network. The first artificial neural network may be configured to determine when the electronic circuit switches from the first state to the second state. The second artificial neural network may be configured to assign the second acoustic signals which are converted into electric signals to the instruction.

The second neural network may consume more storage space, and thus more resources, than the first neural network.

The second neural network may be inactive when the electronic circuit is in the first state.

The apparatus may further comprise a first clamping unit which is configured to establish an electrical connection with a first electrical conductor, and a second clamping unit which is configured to establish an electrical connection with a second electrical conductor. Furthermore, the instruction may be directed towards establishing or disconnecting an electrical connection between a first electric terminal and a second electric terminal. Moreover, the instruction may be directed towards increasing or reducing a voltage and/or a current between the first electric terminal and the second electric terminal. The first clamping unit may form the first electric terminal and the second clamping unit may form the second electric terminal.

The apparatus may be configured to transmit a signal assigned to the instruction to a higher-level control unit if the second acoustic signals converted into electric signals have been assigned to the instruction.

The signal assigned to the instruction may be a bit vector. For example, a unique bit sequence may be assigned to each instruction of the instruction set.

The apparatus and the higher-level control unit may be included in a system, wherein the higher-level control unit may be configured to receive the signal assigned to the instruction via a wired or wireless connection and to output a control signal assigned to the instruction.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a block diagram of an apparatus according to the invention, which is in a sleep state where the apparatus monitors acoustic signals only for a wake word;

FIG. 2 shows a block diagram of the apparatus illustrated in FIG. 1, wherein the apparatus has detected the wake word and monitors the acoustic signals for an instruction of a set of given instructions;

FIG. 3 shows a block diagram of the apparatus illustrated in FIGS. 1 and 2, wherein the apparatus has detected the instruction and executes or outputs the instruction;

FIG. 4 shows a block diagram of the apparatus shown in FIG. 1, which is in the sleep state where the apparatus monitors acoustic signals only for the wake word;

FIG. 5 shows a block diagram of the apparatus illustrated in FIG. 4, wherein the apparatus has detected the wake word and monitors the acoustic signals for an instruction of a set of given instructions;

FIG. 6 shows a block diagram of the apparatus illustrated in FIGS. 4 and 5, wherein the apparatus has not detected the instruction and has returned to the sleep state;

FIG. 7 shows a block diagram of an apparatus according to the invention, which differs from the apparatus shown in FIGS. 1 to 6 in that the apparatus uses different resources for detecting the wake word and for detecting an instruction of the instruction set;

FIG. 8 shows a block diagram of the apparatus illustrated in FIG. 7, wherein the apparatus has detected the wake word and monitors the acoustic signals for an instruction of the instruction set;

FIG. 9 shows a block diagram of the apparatus illustrated in FIGS. 7 and 8, wherein the apparatus has detected the instruction and executes or outputs the instruction; and

FIGS. 10, 11 and 12 illustrate, by way of example, how an apparatus according to the invention can execute or output the instruction.

### DETAILED DESCRIPTION

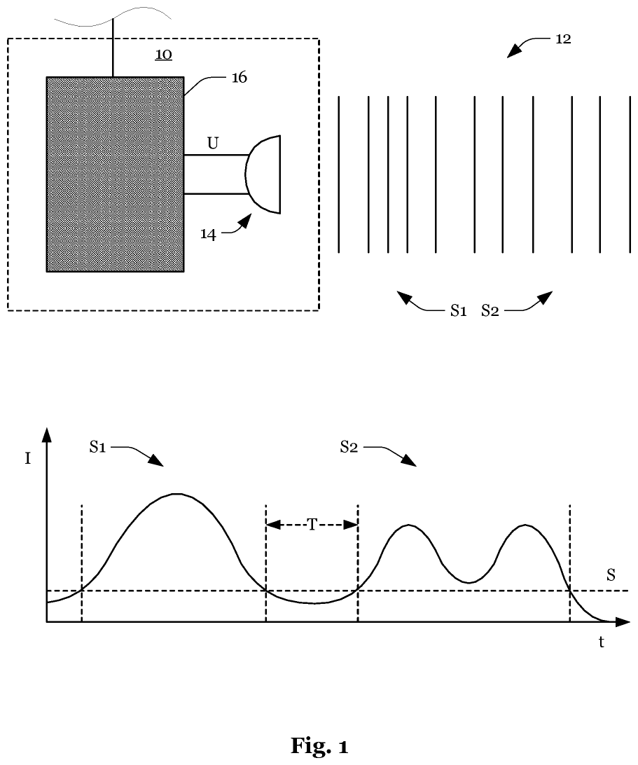

FIG. 1 shows a block diagram of an apparatus 10 according to the invention, which is in a sleep state in which it monitors acoustic signals 12, that are converted by an acoustic sensor 14 into electric signals U, only for a wake word. To this end, apparatus 10 has an electronic circuit 16 which may analyze the acoustic signals 12 regarding their intensity I and divide the acoustic signals 12 into segments S1 and S2. The start and the end of each of the segments S1 and S2 may be determined by evaluating the intensity I of the acoustic signals and detecting regions in which the intensity I of the acoustic signals is below a certain threshold S for a certain period T (or longer). The segments S1 and S2 may be further evaluated regarding their length and processed only if their length does not exceed a certain threshold (e.g., 2 seconds).

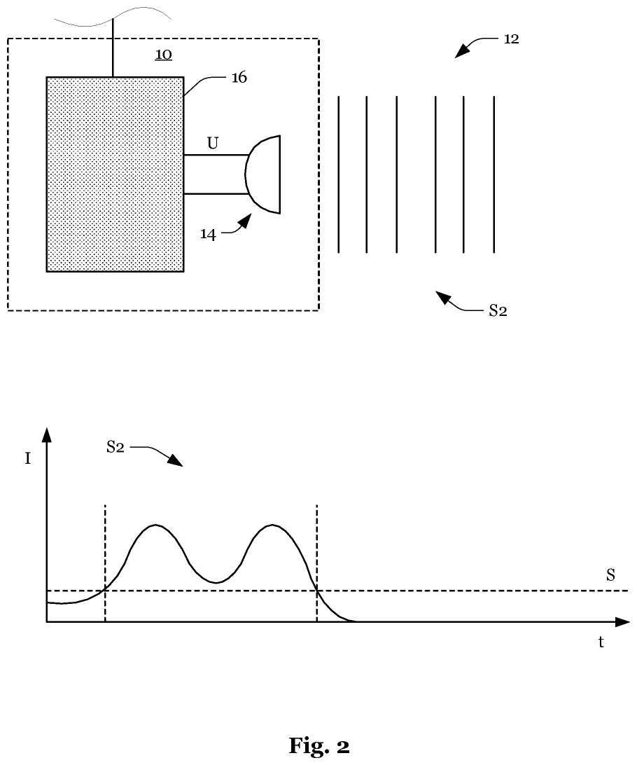

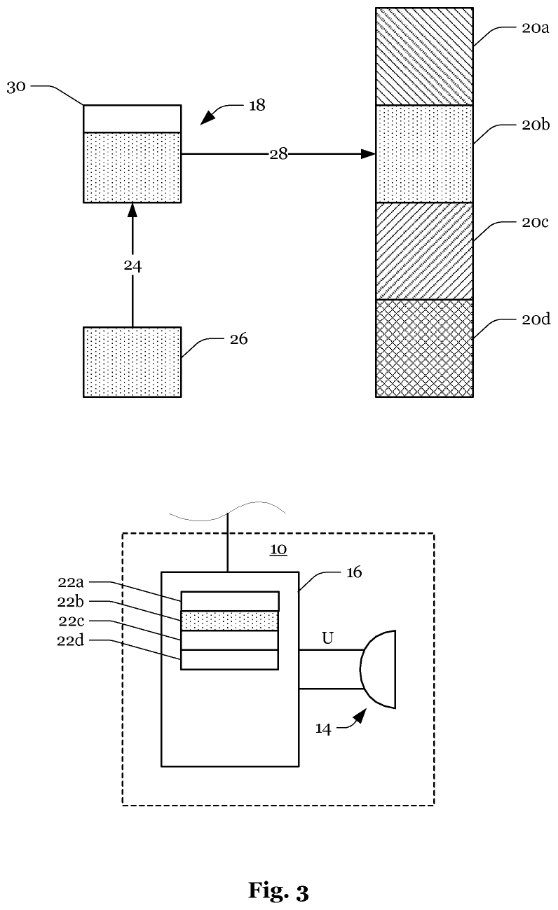

If the electronic circuit 16 detects the wake word in segment S1, it switches, as indicated in FIG. 2, to the wake state and monitors the subsequent segment S2 for the presence of an instruction from a given instruction set. In this process, as schematically illustrated in FIG. 3, the electronic circuit 16 may convert the segment S2 into a spectrogram 18 with a predetermined size and compare the spectrogram 18 to spectrograms 20a, 20b, 20c, 20d of the instructions 22a, 22b, 22c, 22d of the instruction set. For example, the electronic circuit 16 may convert the segment S2 into a spectrogram 26 in a first step 24 and supplement the spectrogram 26 with null values 30 in a second step 28 (e.g. by putting the null values 30 in front of the spectrogram 26 and/or by appending the null values 30 to the spectrogram 26), until the resulting spectrogram 18 has the predetermined size.

If the electronic circuit 16 determines (e.g., by employing an artificial neural network trained in advance with spectrograms 20a, 20b, 20c, 20d of the instructions 22a, 22b, 22c, 22d) that the segment S2 includes one of the instructions 22a, 22b, 22c, 22d, the electronic circuit 16 assigns the electric signals U thereto. The electronic circuit 16 may then cause the instruction 20b to be executed. In addition to an artificial neural network for recognizing the instruction 22b, the electronic circuit 16 may also include an artificial neural network for recognizing the wake word. In this case, the recognition of the wake word may be implemented in a manner similar or identical to the recognition of the instructions 22a, 22b, 22c, 22d. However, if only one wake word is used, or a number of wake words that is smaller than the number of instructions 22a, 22b, 22c, 22d included in the instruction set, the artificial neural network may require fewer resources for recognizing the wake word or wake words.

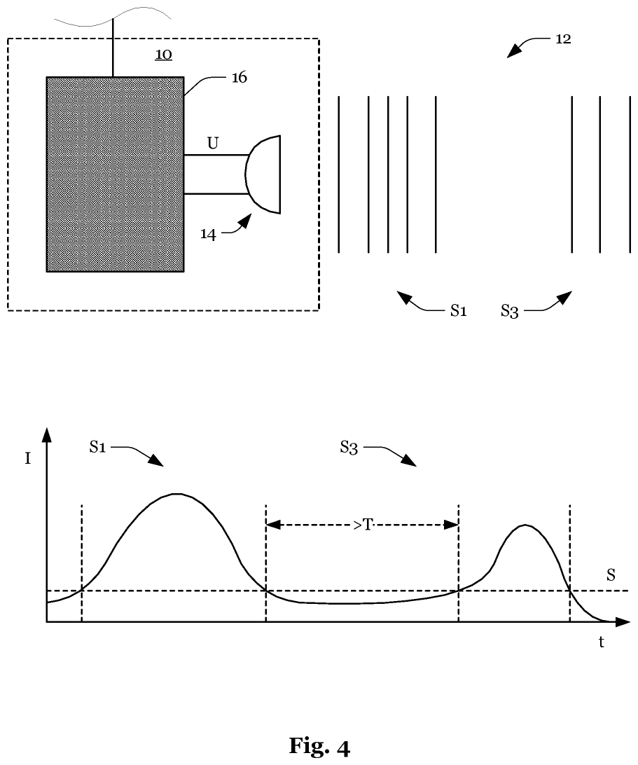

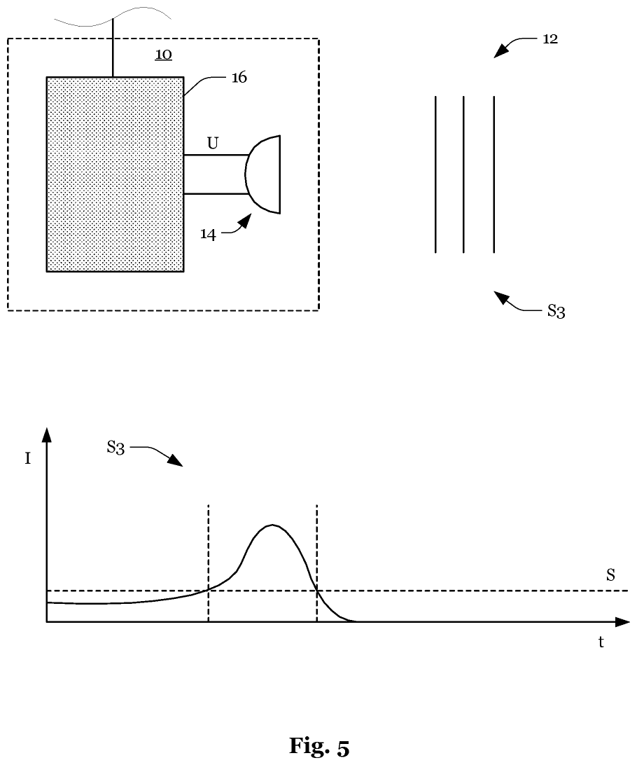

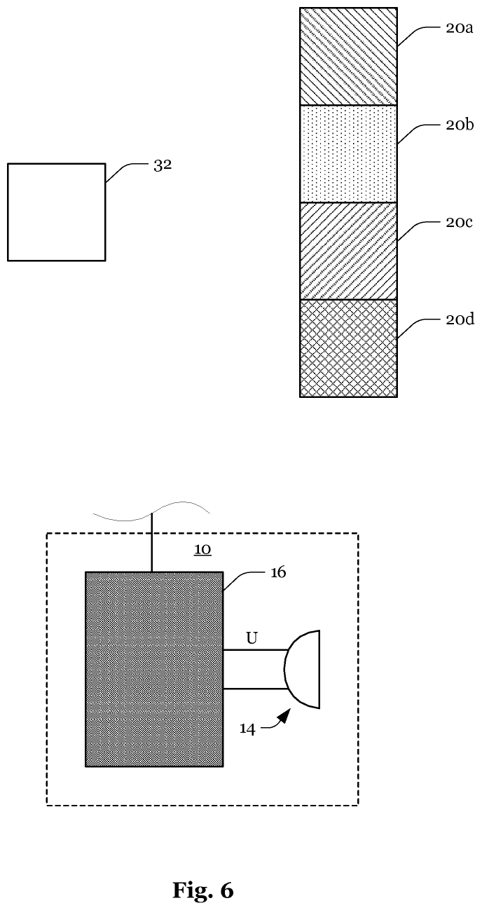

FIGS. 4, 5, and 6 illustrate another progression of events (which deviates from the progression of events illustrated in FIGS. 1, 2, and 3). As in FIG. 1, the electronic circuit 16 detects the wake word in segment S1 and switches, as indicated in FIG. 5, into the wake state. In the wake state, the electronic circuit 16 monitors the segment S3 following the wake word for the presence of an instruction. If, as illustrated in FIG. 6, the segment S3, or the spectrogram 32 representing segment S3, includes no instruction, or if segment S3, or the spectrogram 32 representing segment S3, cannot be assigned to any of the instructions 22a, 22b, 22c, 22d (maybe for other reasons), the electronic circuit 16 switches to the sleep state (immediately or after a certain waiting period). The electronic circuit 16 may then remain in the sleep state until the wake word is detected again.

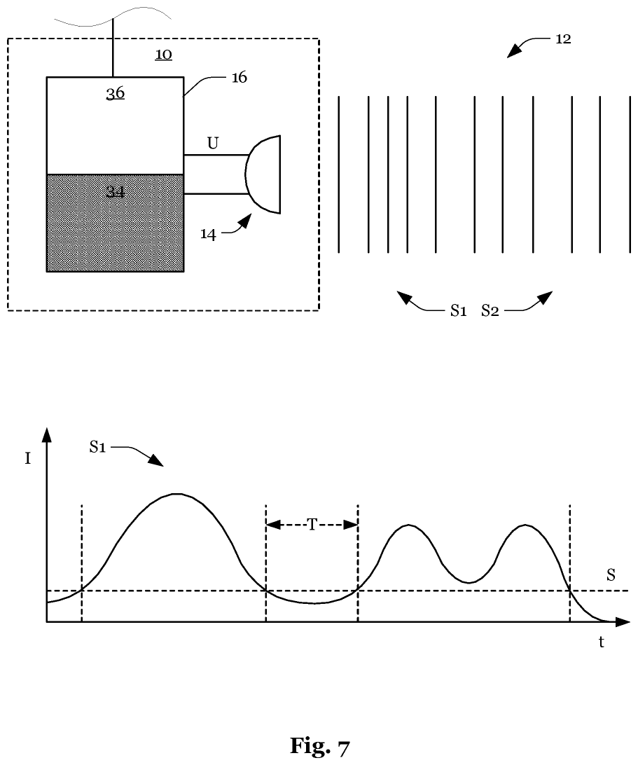

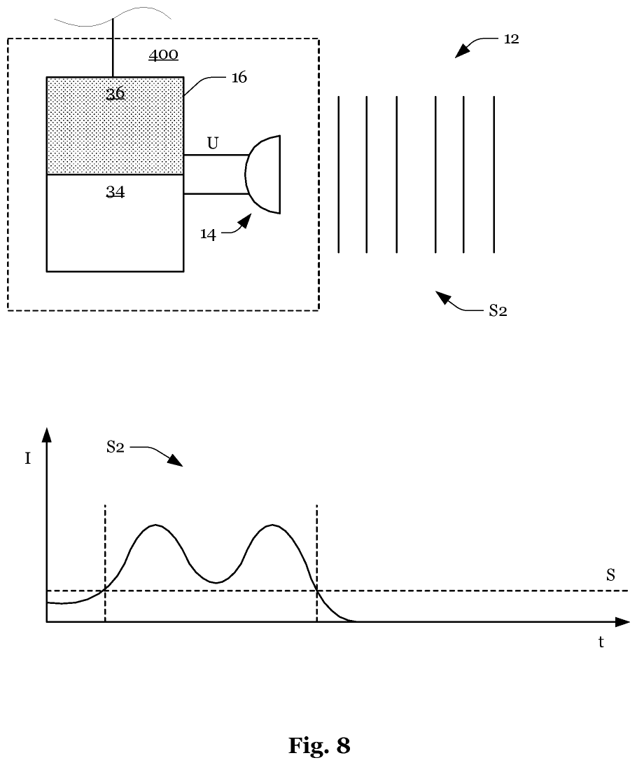

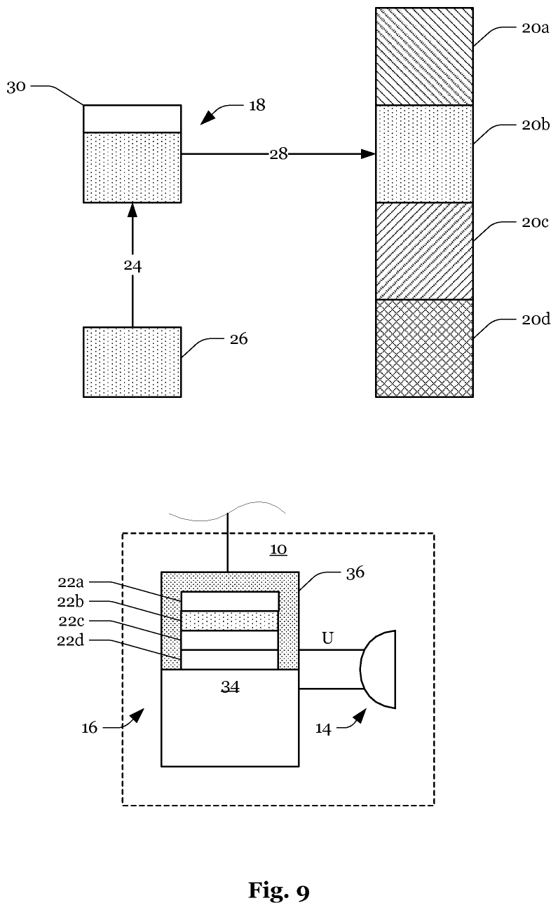

As illustrated in FIG. 7, only the recognition of the wake word may be activated while the electronic circuit 16 is in the sleep state. For example, only a first artificial neural network 34 may be active while the electronic circuit 16 is in the sleep state. Said first artificial neural network 34 may be trained solely for recognizing the wake word and therefore require relatively few resources. Said low resource consumption may, for example, result in a relatively low power consumption of apparatus 10 in the sleep state. If the electronic circuit 16 detects the wake word in segment S1, the electronic circuit 16 switches, as indicated in FIG. 8, to the wake state.

As is illustrated in FIG. 8, only the recognition of one of the instructions 22a, 22b, 22c, 22d from the instruction set may be active in the wake state. For example, while the electronic circuit 16 is in the sleep state, (only) a second artificial neural network 36 may be activated which is trained to recognize the instructions 22a, 22b, 22c, 22d of the instruction set. Said second artificial neural network 36 may require more resources than the first artificial neural network 34. This may result in a relatively higher power consumption of apparatus 10 in the wake state. Said second artificial neural network 36 may check segment S2 which follows the first segment S1 for the presence of one of the instructions 22a, 22b, 22c, 22d and, if the instruction 22b is recognized, cause the latter to be executed.

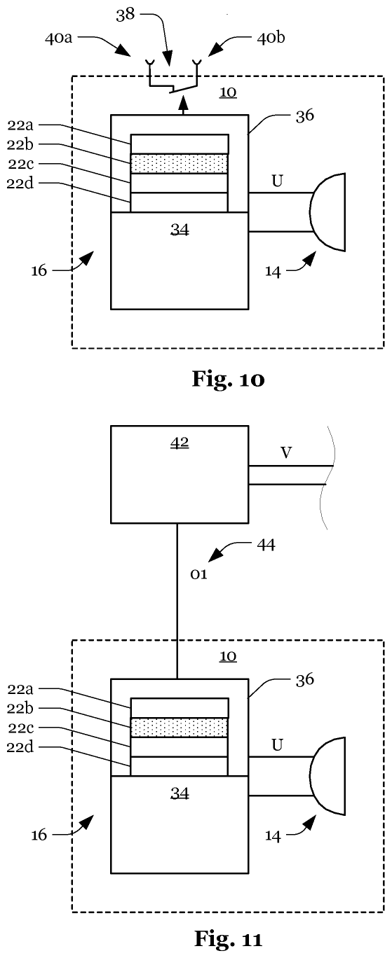

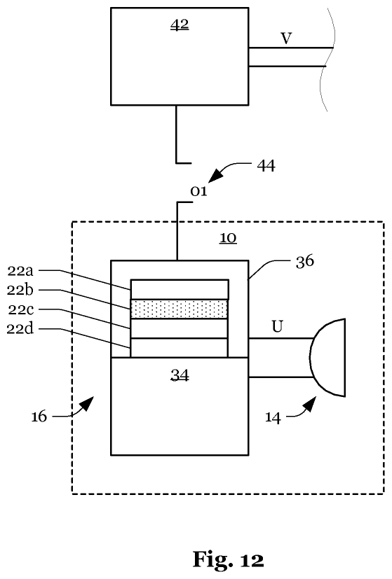

As shown in FIG. 10, apparatus 10 may be configured to open or close a switch 38 (arranged in apparatus 10) when the instruction 22b is recognized. By closing the switch 38, two terminals, which may be configured as clamping units 40a and 40b, may be connected to each other, whereby an electrical consumer such as an actuator may be activated or deactivated. Alternatively, apparatus 10 may be configured to increase or reduce a voltage and/or a current between the terminals if the instruction 22b is recognized. Moreover, as illustrated in FIG. 11, the recognized instruction 22b may be transferred (e.g., in the form of a bit vector 44) to a higher-level control unit 42. The higher-level control unit 42 may process the instruction 22b and output corresponding control signals V. For example, the control signals V may cause a switch (not shown) to be opened or closed, whereby an electrical consumer such as an actuator may be activated or deactivated. Alternatively, the control signals V may cause a voltage applied to the electrical consumer or a current through the consumer to be increased or reduced. As illustrated in FIG. 12, the recognized instruction 22b may also be transferred to the higher-level control unit 42 via a wireless connection (instead of a wired connection).

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An apparatus for locally recognizing an instruction of a given set of instructions, the apparatus comprising:
an acoustic sensor configured to convert acoustic signals into electric signals; and
an electronic circuit configured to switch from a first state to a second state based on first acoustic signals that are converted into electric signals and configured to ignore second acoustic signals that are converted into electric signals when the electronic circuit is in the first state and to assign the second acoustic signals to the instruction when the electronic circuit is in the second state.

2. The apparatus of claim 1, wherein the first acoustic signals immediately precede the second acoustic signals and indicate to the electronic circuit that the second acoustic signals include a spoken instruction of the instruction set.

3. The apparatus of claim 1, wherein the electronic circuit is further configured to switch back to the first state if the instruction is not recognized and/or in response to another instruction of the instruction set.

4. The apparatus of claim 1, wherein the state change and the instruction assignment are realized independent of each other and differ from each other with regard to their resource consumption.

5. The apparatus of claim 4, wherein the apparatus is configured to provide fewer resources for the state change than for the instruction assignment.

6. The apparatus of claim 1, wherein the electronic circuit is configured to subject the electric signals to a frequency analysis.

7. The apparatus of claim 1, wherein the electronic circuit comprises a processor and a storage unit which stores a program that is to be executed by the processor, and wherein the program implements a first artificial neural network.

8. The apparatus of claim 7, wherein the storage unit stores a further program that is to be executed by the processor, wherein the further program implements a second artificial neural network, wherein the first artificial neural network is configured to determine when the electronic circuit is to switch from the first state to the second state, and wherein the second artificial neural network is configured to assign the second acoustic signals, which are converted into electric signals, to the instruction.

9. The apparatus of claim 8, wherein the second neural network is not active when the electronic circuit is in the first state.

10. The apparatus of claim 1, further comprising:
a first clamping unit configured to establish an electrical connection with a first electrical conductor; and
a second clamping unit configured to establish an electrical connection with a second electrical conductor,
wherein the instruction is directed towards establishing or disconnecting an electrical connection between a first electric terminal and a second electric terminal or towards increasing or reducing a voltage and/or a current between the first electric terminal and the second electric terminal.

11. The apparatus of claim 10, wherein the first clamping unit forms the first electric terminal, and the second clamping unit forms the second electric terminal.

12. The apparatus of any claim 11, wherein the apparatus is further configured to transmit a signal assigned to the instruction to a higher-level control unit if the second acoustic signals converted into electric signals were assigned to the instruction.

13. The apparatus of claim 12, wherein the signal assigned to the instruction is a bit vector.

14. A system comprising the apparatus of claim 12 and a higher-level control unit, wherein the higher-level control unit is configured to receive the signal assigned to the instruction via a wired or wireless connection and to output a control signal assigned to the instruction.
